(19) United States
(12) Patent Application Publication
(10) Pub. No.: US 2018/0039422 A1
(43) Pub. Date: Feb. 8, 2018

(54) SOLID STATE STORAGE CAPACITY MANAGEMENT SYSTEMS AND METHODS

(71) Applicant: Alibaba Group Holding Limited, George Town (KY)

(72) Inventor: Shu LI, Santa Clara, CA (US)

(21) Appl. No.: 15/230,136

(22) Filed: Aug. 5, 2016

(51) Int. Cl. G06F 3/06; G06F 12/10; G06F 12/02

(52) U.S. Cl. CPC G06F 3/0608; G06F 12/0246; G06F 12/10; G06F 3/0638; G06F 3/0679; G06F 2212/1044; G06F 2212/152; G06F 2212/2022; G06F 2212/7201

(57) ABSTRACT

The present invention facilitates efficient and effective information storage device operations. In one embodiment, a method comprises: receiving a first amount of original information associated with a first set of logical storage address blocks; condensing the first amount of original information into a first amount of condensed information wherein the size of the first amount of condensed information is smaller than the first amount of original information and the difference is a first capacity saving; storing the first amount of condensed information in a first set of physical storage address blocks; tracking the first capacity saving; and using at least a portion of the first capacity saving for storage activities other than a direct bonding address coordination space for the first amount of original information.

### FIELD OF THE INVENTION

The present invention relates to the field of information storage capacity adjustment management.

### BACKGROUND OF THE INVENTION

Numerous electronic technologies such as digital computers, calculators, audio devices, video equipment, and telephone systems facilitate increased productivity and cost reduction in analyzing and communicating data and information in most areas of business, science, education, and entertainment. Frequently, these activities involve communication and storage of large amounts of information and the complexity and costs of networks and systems performing these activities are can be immense. Solid state drives (SSDs) are often used to provide fixed storage space (e.g., similar to the way some hard disk drives (HDDs) are used) in a variety of environments (e.g., data centers, server farms, in the cloud, etc.)

NAND flash SSDs typically facilitate relatively rapid access to stored information but tend to have other characteristics that can adversely impact overall performance. For example, flash device information updates typically involve write amplification that can adversely impact a device's effective life and consume bandwidth. There is usually a correspondence between the amount of adverse impacts due to write amplification and the size of the data write operation. When small data storage block sizes are used the SSD write amplification is often not critical in applications with random writes. However, there are a number of reasons to use large block sizes. Many systems still use legacy large block sequential writes (e.g., to meet Input/Output per second (IOPS) requirement formally associated with HDDs, etc.). Also, distributed file systems often merge inputs/outputs (IOs) to form large size blocks used to flush memory.

In an effort to reduce write sizes, some traditional systems try to condense the data. However, there can be costs or adverse impacts associated with data compression that can lead to reduction or degradation of overall performance (e.g., in terms of chip area consumed by compression components, throughput of information, power consumption, etc.). Thus, there is often a tradeoff between the costs or adverse impacts associated with data compression and the benefits compression can have with respect to write amplification mitigation. As a result, compression has been tried in SSDs, but given the relatively high costs and adverse impacts of compression it is not broadly used yet in SSDs.

### SUMMARY

The present invention facilitates efficient and effective information storage device operations. In one embodiment, a bonus capacity method comprises: receiving a first amount of original information associated with a first set of logical storage address blocks; condensing the first amount of original information into a first amount of condensed information wherein the size of the first amount of condensed information is smaller than the first amount of original information and the difference is a first capacity saving; storing the first amount of condensed information in a first set of physical storage address blocks; tracking the first capacity saving; and using at least a portion of the first capacity saving for storage activities other than a direct bonding address coordination space for the first amount of original information. The storage activities other than a direct bonding address coordination space can include a variety of activities (e.g., converting the first capacity saving into a new bonus drive, use in a new bonus volume, over-provisioning, etc.).

The tracking of the first capacity saving and the converting of the first capacity saving into a new bonus drive or volume is transparent to a host, and the host continues to consider the physical block addresses as being assigned to the original data. In one embodiment, a bonus mapping relation is performed in a middle translation layer between a logical block address layer and a flash translation layer. Adjusting the new bonus drive can be performed during actual in-situ data condensing. The bonus mapping relation between logical block addresses and physical block addresses can be built online during usage of the bonus block. Condensing can be bypassed when compression gains associated with the condensing are below a threshold.

In one embodiment, steps can be repeated for additional information. In one exemplary implementation, the method further comprises: receiving a second amount of original information associated with a second set of logical storage address blocks; condensing the second amount of original information into a second amount of condensed information, wherein the size of the second amount of condensed information is smaller than the second amount of original information and the difference is a second capacity savings; storing the second amount of condensed information in a second set of physical storage address blocks; tracking the second capacity savings; and using at least a portion of the second capacity saving for storage activities other than a direct bonding address coordination space for the second amount of original information. Data condensing can be managed efficiently globally across multiple storage drives.

In one embodiment, a storage system comprises: a host interface, a condensing component, a middle translation layer component, and a NAND flash storage component. The host interface is configured to receive information from a host and send information to a host, wherein the information includes original information configured in accordance with logical block addresses. The condensing component is configured to condense the original information into condensed information. The middle translation layer component is configured to arrange the condensed information in accordance with middle translation layer block addresses and track capacity savings due to a difference in the original information and condensed information. The NAND flash storage component stores the condensed information in accordance with physical block addresses and provides feedback to the middle translation layer component.

In one exemplary implementation, the middle translation layer component initiates creation of a new drive based upon the capacity savings. The middle translation layer component can perform operations on a modular level enabling recursive feedback from the physical layer. The capacity savings are utilized in the creation a new bonus drive and the creation is transparent to the host.

A bonus capacity method can comprise: receiving logical block addressed original information associated with a first amount of physical block addresses; condensing the logical block addressed original information into condensed information and associating the condensed information with a second amount of physical block addresses; tracking a capacity difference between the first amount of physical block addresses and the second amount of physical block addresses; and designating the capacity difference for use as bonus storage, wherein the condensing, tracking and use of the capacity difference is transparent to a host. The bonus storage can be used to create a bonus drive after a logical block address count of an original drive is used up. The capacity of the bonus drive can be updated after a group of write operations and a logical block count of the bonus dive can vary.

The tracking and the designating the capacity difference can be performed in a middle translation layer between a logical block address layer and a flash translation layer. The middle translation layer ensures compatibility with a host. The middle translation layer handles updates to form a bonus drive based upon the capacity difference. A middle translation layer block address count and a physical block address count are the same and constant during usage. The middle translation layer operations can create self-defined unique interfaces between the host and flash translation layer to realize creation of bonus drives.

### DESCRIPTION OF THE DRAWINGS

The accompanying drawings, which are incorporated in and form a part of this specification, are included for exemplary illustration of the principles of the present invention and are not intended to limit the present invention to the particular implementations illustrated therein. The drawings are not to scale unless otherwise specifically indicated.

FIG. 1 is a block diagram of an exemplary bonus capacity storage method in accordance with one embodiment.

FIG. 2A is a block diagram of an exemplary storage space in accordance with one embodiment.

FIG. 2B is a block diagram of exemplary information storage in accordance with one embodiment.

FIG. 3A is a block diagram of exemplary additional information storage in accordance with one embodiment.

FIG. 3B is a block diagram of exemplary traditional information storage.

FIG. 4A is a block diagram of a traditional SSD product data path.

FIG. 4B is a block diagram of a SSD product in accordance with one embodiment.

FIG. 5 is a block diagram of an exemplary storage organization with logical volume management (LVM) in accordance with one embodiment.

FIG. 6 is a block diagram of an exemplary distributed system simultaneously running multiple services on clusters in accordance with one embodiment.

FIG. 7A is a block diagram of a bonus storage method in accordance with one embodiment.

FIG. 7B is a block diagram of an exemplary data condensing method in accordance with one embodiment.

FIG. 8 is a block diagram of a bonus drive generation mechanism in accordance with one embodiment.

FIG. 9A is a block diagram of an exemplary application of a bonus drive in accordance with one embodiment.

FIG. 9B is another block diagram an exemplary application of a bonus drive in accordance with one embodiment.

FIG. 10A is a block diagram of a bonus drive generation mechanism in accordance with one embodiment where some original data is not condensed.

FIG. 10B is a block diagram of an exemplary application of utilizing bonus capacity in accordance with one embodiment.

FIG. 11A is a block diagram of a tradition approach 1110 without a middle translation layer (MTL).

FIG. 11B is a block diagram of an exemplary middle translation layer (MTL) approach 1120 in accordance with one embodiment.

FIG. 12 is a block diagram of an exemplary format conversion hierarchy in accordance with one embodiment.

FIG. 13 is a block diagram of the storage block formats at different layers in accordance with one embodiment.

FIG. 14 is the flow chart of an exemplary data scheme condensing method in accordance with one embodiment.

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications, and equivalents, which may be included within the spirit and scope of the invention as defined by the appended claims. Furthermore, in the following detailed description of the present invention, numerous specific details are set forth in order to provide a thorough understanding of the present invention. However, it will be obvious to one ordinarily skilled in the art that the present invention may be practiced without these specific details. In other instances, well known methods, procedures, components, and circuits have not been described in detail so as not to unnecessarily obscure aspects of the current invention.

The presented storage capacity management systems and methods facilitate efficient and effective information storage and enhanced resource utilization in Solid State Drives (SSDs). In one embodiment, original data is condensed and the difference in the original data amount and condensed data amount is considered a storage capacity savings or bonus storage capacity. The bonus storage capacity can be used to adjust the effective storage capacity available for various storage activities (e.g., bonus storage space, over-provisioning, etc.) and can be adjusted in real time on the fly. In one exemplary implementation, the bonus storage capacity is exposed to the host through a middle translation layer between the flash translation logic and the file system. The logical address capacity of a physical SSD as “seen” by a host can be flexible and extendable while its physical capacity is fixed. This in effect can enable more logical block addresses (LBAs) to be stored in an SSD with a fixed number of physical block addresses (PBAs), as compared to traditional one to one LBA to PBA storage approaches. The storage capacity management can utilize the bonus storage capacity for a variety of activities other than a direct bonding address coordination space can include a variety of activities (e.g., converting the bonus capacity saving into a new bonus drive, use in a new bonus volume, over-provisioning, etc.).

The systems and methods include condensing original data before it is actually written to a physical location. The condensing can include data reduction to remove redundancy before the data is written, and a configuration pass through the kernel stack online without rebooting or reformatting (which otherwise involve moving the huge amount of data around). In one exemplary implementation, space availability per characterization statistics and analysis on the stored data is released, then data redundancy in the original data is removed both globally and locally to reduce the total data amount eventually written into physical NAND flash pages. The bonus storage capacity can be exposed in the form of multiple resizable logical volumes even though the physical capacity of the SSD is constant. The systems and methods can effectively extend the controllability on the individual SSD drive and flexibly mount the different total LBA counts for different workloads, which in turn can reduce drive space waste and enhance efficiency.

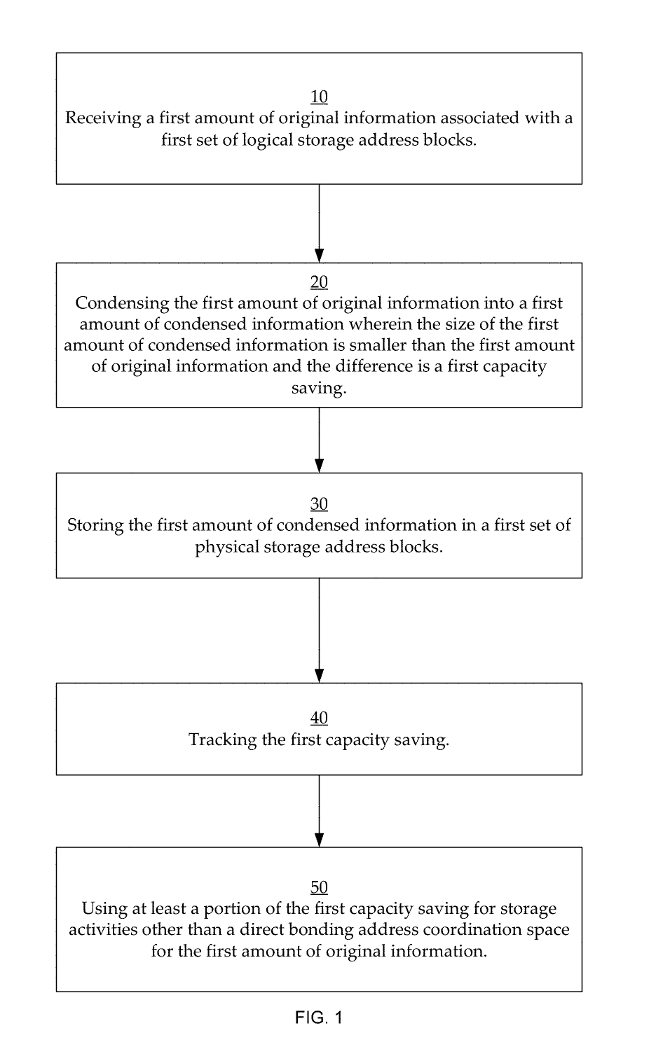

FIG. 1 is a block diagram of an exemplary bonus capacity storage method in accordance with one embodiment.

In block 10, a first amount of original information associated with a first set of logical storage address blocks is received. The first amount of original information can correspond to a plurality of logical block addresses.

In block 20, the first amount of original information is condensed into a first amount of condensed information. The size of the first amount of condensed information is smaller than the first amount of original information and the difference is a first capacity saving.

In block 30, the first amount of condensed information is stored in a first set of physical storage address blocks. The first amount of condensed information can correspond to a plurality of physical block addresses. There can be a smaller number of physical block addresses than logical block addresses associated with the uncondensed original information.

In block 40, the first capacity saving is tracked. The tracking of the first capacity saving is transparent to a host and the host continues to consider the physical block addresses assigned to the original data.

In block 50, at least a portion of the first capacity saving is used for storage activities other than a direct bonding address coordination space for the first amount of original information. The use of the first capacity saving can also be transparent to a host. It is appreciated the first capacity saving can be used for a variety of activities (e.g., used in a new bonus drive, used in a new bonus volume, used for over-provisioning, etc.).

In one embodiment, at least a portion of the first capacity saving is converted into a new bonus drive. A bonus mapping relation is performed in a middle translation layer between a logical block address layer and a flash translation layer. Adjusting the new bonus drive can be performed during actual in-situ data condensing and the bonus mapping can be built online during usage of the bonus block. In one embodiment, condensing is bypassed when compression gains associated with the condensing are below a threshold.

In one embodiment, steps of the exemplary bonus capacity storage method can be repeated for additional information. In one exemplary implementation, the method further comprises: receiving a second amount of original information associated with a second set of logical storage address blocks; condensing the second amount of original information into a second amount of condensed information, wherein the size of the second amount of condensed information is smaller than the second amount of original information and the difference is a second capacity savings; storing the second amount of condensed information in a second set of physical storage address blocks; tracking the second capacity savings; and using at least a portion of the second capacity saving for storage activities other than a direct bonding address coordination space for the second amount of original information. It is appreciated the second capacity saving can be combined for use with the first capacity saving. In one exemplary implementation, the first capacity savings is combined with the second capacity savings in a new bonus drive or volume. Data condensing can be managed efficiency of data condensing globally across multiple storage drives.

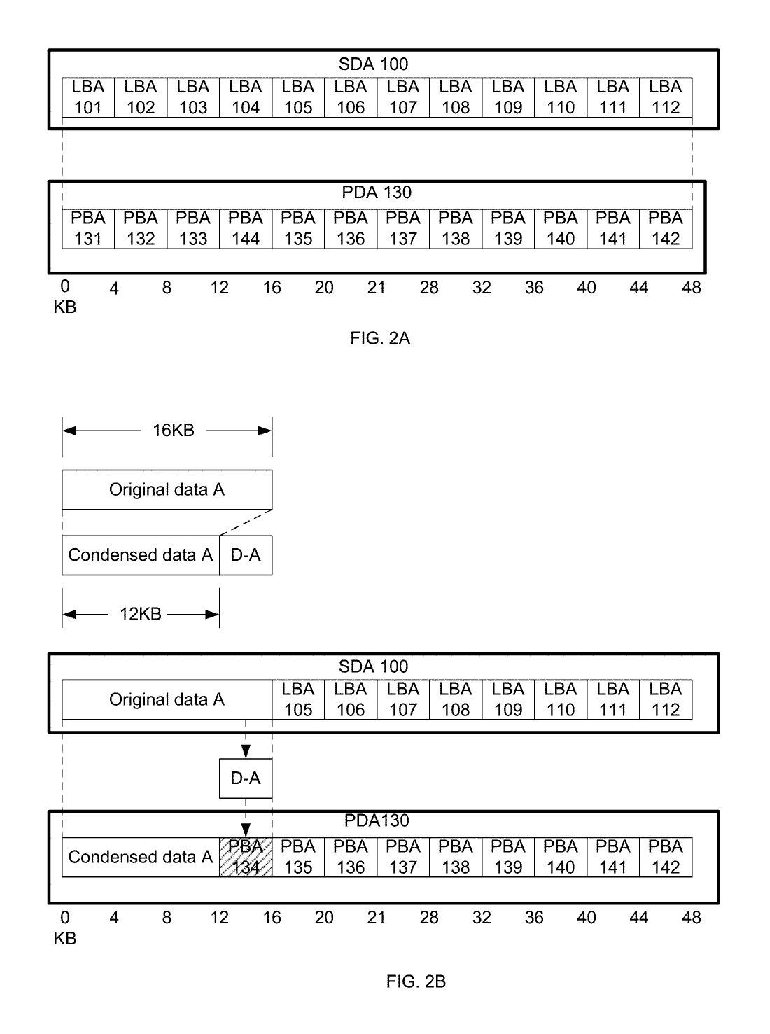

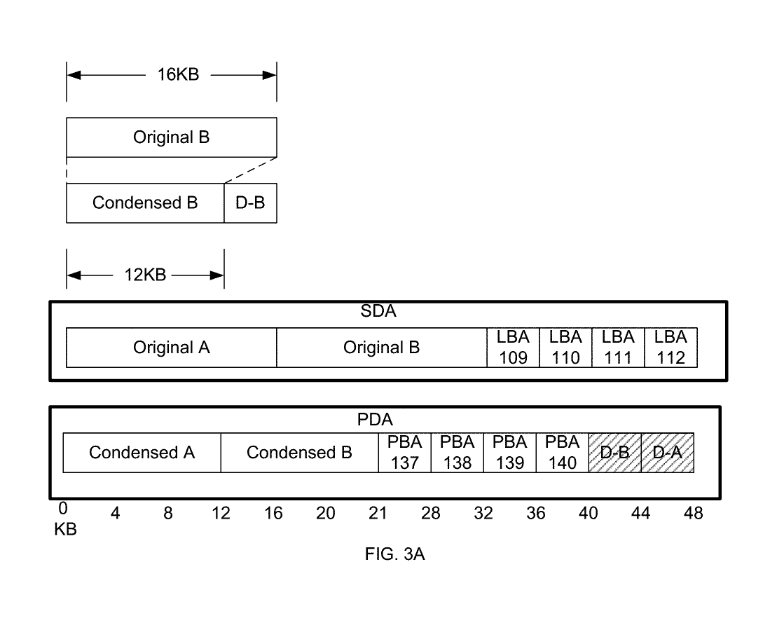

FIG. 2A is a block diagram of an exemplary storage space in accordance with one embodiment. The top half is a block diagram of an exemplary portion of a scalable disk array (SDA) with a logical block address (LBA) configuration in accordance with one embodiment. The SDA portion includes logical block addresses LBA 101, LBA 102, LBA 103, LBA 104, LBA 105, LBA 106, LBA 107, LBA 108, LBA 109, LBA 110, LBA 111, and LBA 112. In one exemplary implementation, the respective blocks can be considered a count of LBAs. In the illustrated example, the LBA count is 12 since there are 12 LBA blocks. The bottom half of FIG. 2A is a block diagram of an exemplary portion of a parallel disk array (PDA) with a physical block address (PBA) configuration in accordance with one embodiment. The PDA portion includes physical block addresses PBA131, PBA 132, PBA 133, PBA 144, PBA 135, PBA 136, PBA 137, PBA 138, PBA 139, PBA 140, PBA 141, and PBA 142. In one exemplary implementation, the respective blocks can be considered a count of PBAs. In the illustrated example, the PBA count is twelve since there are twelve PBA blocks. In one embodiment, the PBA blocks are 4 k Bytes in size and the respective LBAs are also 4 k Bytes in size (the KB incremental increases by 4 k Bytes from 0 KB to 48 KB are indicated at the bottom of the FIGS. 2A and 2B).

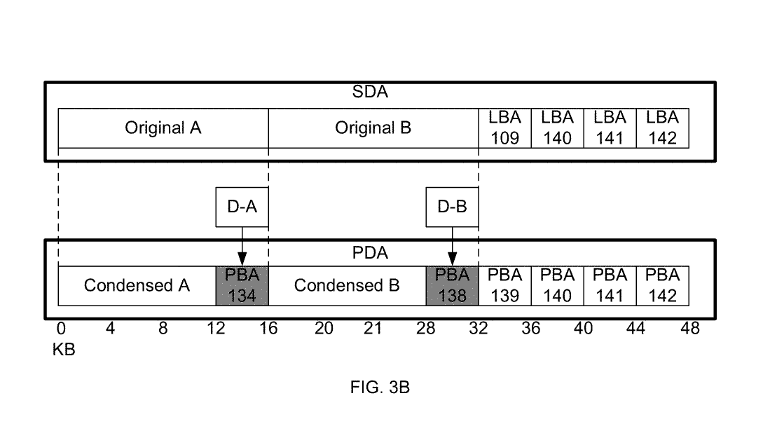

FIG. 2B is a block diagram of exemplary information storage in accordance with one embodiment. Initially, a chunk of original data A is received and condensed into condensed data A. The difference in the size or amount of information between the original data A and condensed data A is referred to as D-A. The original data A is 16 k Bytes and is associated with logical block addresses LBA 101, LBA 102, LBA 103, and LBA 104 in LBA layer 100. However, it is actually the condensed data A which is stored in the physical memory and since the condensed data A is only 12 k Bytes of data, it is stored in PBA 131, PBA 132, and PBA 133 in PDA layer 130. Again, the PBA blocks are 4 k Bytes in size and the respective LBAs are also 4 k Bytes in size (the KB incremental increases of 4 k Bytes from 0 to 48 are indicated at the bottom of the Figure). As is illustrated in the FIG. 2B, the difference D-A allows PBA 134 to remain empty. The PBA 134 is available for use as bonus storage that can be used to store other information, unlike the traditional approach in which the PBA 134 is left empty but remains committed and associated with the original data A. The difference between being able to use the condensing differences for bonus storage versus not being able to use condensing differences in traditional approaches is illustrated in FIGS. 3A and 3B.

FIG. 3A is a block diagram of exemplary additional information storage in accordance with one embodiment. A chunk of original data B is received and condensed into condensed data B. The difference in the size or amount of information between the original data B and condensed data B is referred to as D-B. The original data B is 16 k Bytes and is associated with logical block addresses LBA 105, LBA 106, LBA 107, and LBA 108. However, it is actually the condensed data B which is stored in the physical memory and since the condensed data B is only 12 k Bytes of data, it is stored in PBA 134, PBA 135, and PBA 136. As is illustrated in the FIG. 3A, the difference D-B allows one more PBA to remain empty. For illustrative purposes, the free or bonus PBAs are shown in PBA 141 and PBA 142 and designated as D-B and D-A. The PBA 141 and PBA 142 (aka D-B and D-A) are available for use as bonus storage that can be used to store other information, unlike a typical traditional approach.

FIG. 3B is a block diagram of exemplary traditional information storage. In traditional information storage approaches there is typically a direct one to one bonding or association of LBAs to PBAs. In order to maintain a strict one to one storage block correspondence between the logical block addresses and the physical block addresses, the difference D-A is associated with PBA 134 and the difference D-B is associated with PBA 138. The PBA 134 and PBA 138 are left empty but remain committed and associated with the original data A and original data B respectively. The PBA 134 and PBA 138 act as direct bonding address coordination spaces to account for the respective differences D-A and D-B and enable preservation of the direct one to one bonding or association of LBAs to PBAs for the original data (even though it is the condensed data that is actually stored in the PDA 130). Thus, the PBA 134 remains committed and associated with the original data A in a traditional approach. The PBA 134 is not available for use in storing condensed data B and can not be used for other activities (e.g., as bonus storage space, over-provisioning, etc.), it just remains empty. Similarly, PBA 138 remains committed and associated with the original data B in a traditional approach. The PBA 138 is not available and can not be used for other activities, it just remains empty.

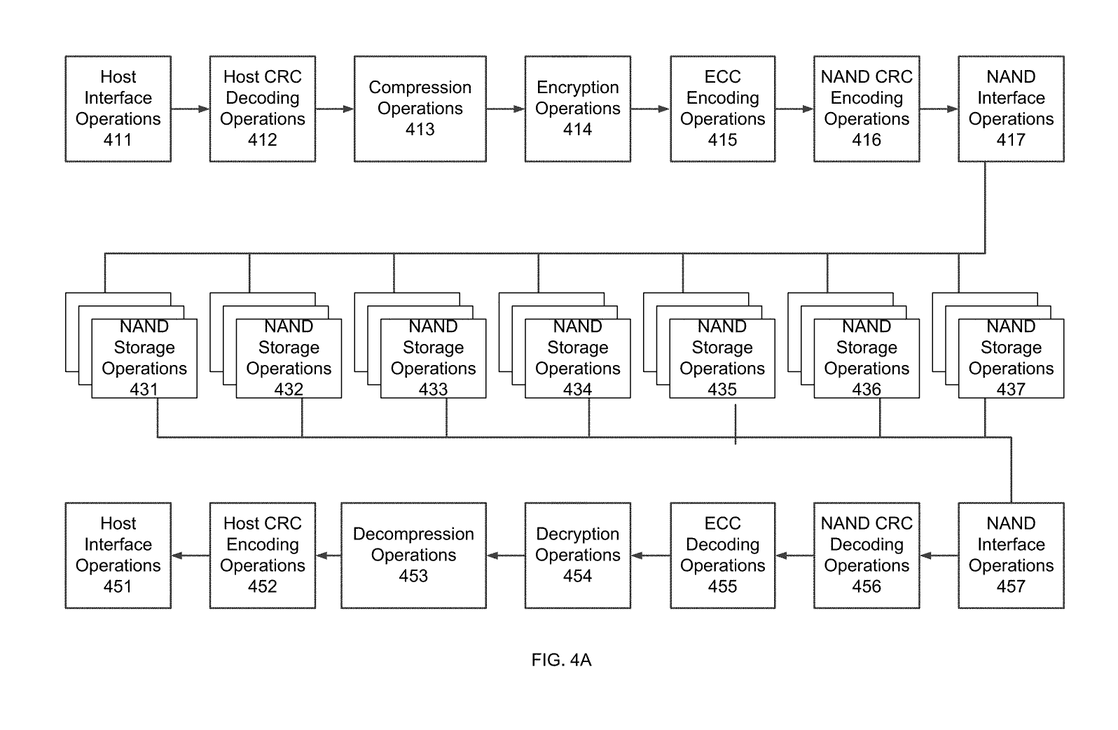

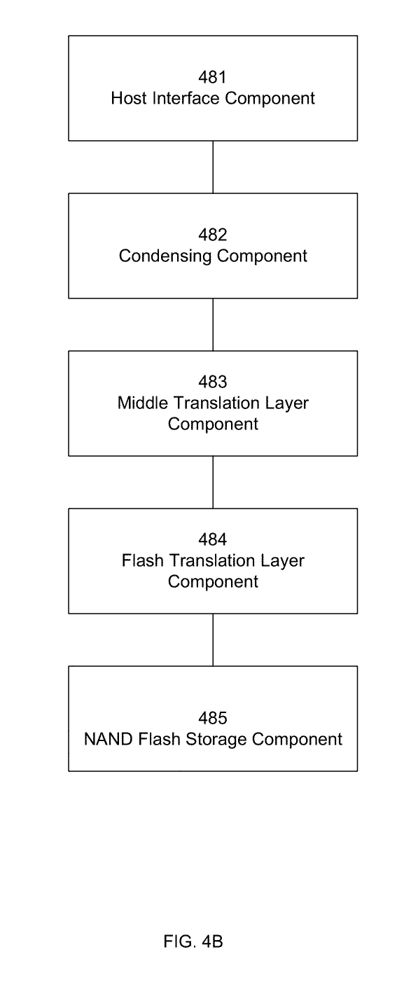

Some conventional SSD products have an integrated compression function inside their controller. One example of a traditional SSD product data path is illustrated in FIG. 4A. The SSD product data path includes host interface operations 411, host cyclic redundancy check (CRC) decoding 412, compression 413, encryption 414, error correcting code (ECC) encoding 415, NAND CRC encoding 416, NAND interface operations 417, NAND component storage operations 431 through 437, NAND interface operations 457, NAND CRC decoding 456, ECC decoding 455, decryption 454, decompression 453, host CRC encoding 452, and host interface operations 451. In one embodiment, some of the different respective operations in the SSD product data path can be performed by one component (e.g., host interface operations 411 and host interface operations 451 can be performed by a single input/output host interface component, encryption operations 414 and decryption operations 454 can be performed by a single encryption/decryption component, etc.) The compression engine is in series with the other modules in the main data path. After the SSD receives host data and checks the parity, the data is compressed within its block (e.g., 4 k Bytes, 512 Bytes, etc.). Each original data chunk can be compressed more or less based on the contents of the block and compressibility of the different kinds of files. The data can be encrypted. Since the compression engine processing and the decompression engine processing are serialized in the data path, the compression function can have significant impacts on the throughput and the latency of an SSD. Especially for high throughput requirements, multiple hardware compression engines are often used, and consequently, occupy much more silicon area and consume more power.

FIG. 4B is a block diagram of a SSD 480 product or system in accordance with one embodiment. The storage system comprises host interface component 481, condensing component 482, middle translation layer component 483, flash translation layer (FTL) component 484, and NAND flash storage component 485. The host interface component 481 is configured to receive information from a host and send information to a host, wherein the information includes original information configured in accordance with logical block addresses. The condensing component 482 is configured to condense the original information into condensed information. The middle translation layer component 483 is configured to arrange the condensed information in accordance with middle translation layer block addresses and track capacity savings due to a difference in the original information and condensed information. The flash translation layer (FTL) component 484 performs flash translation layer control. The NAND flash storage component 485 stores the condensed information in accordance with physical block addresses and provides feedback to the middle translation layer component.

In one exemplary implementation, the middle translation layer component 483 initiates creation of a new drive based upon the capacity savings. The middle translation layer component 483 can perform operations on a modular level enabling recursive feedback from the physical layer. The capacity savings are utilized in the creation a new bonus drive and the creation is transparent to the host.

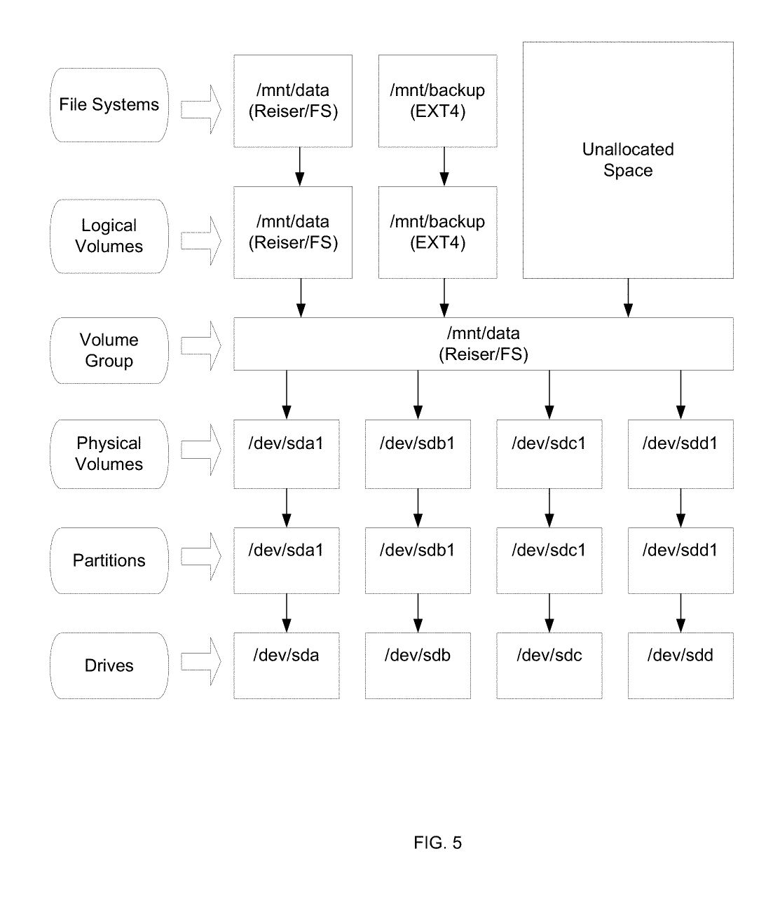

FIG. 5 is a block diagram of an exemplary storage organization with logical volume management (LVM) in accordance with one embodiment. The relationship between logical volume management layers in accordance with one exemplary implementation is illustrated. The LVM can include a hierarchy comprising a physical volume, a volume group and logical volumes. Each layer or level in the hierarchy can build on one another, from physical volume to volume group to logical volume to file system. A logical volume can be extended within the free space of the underlying volume groups. On the other hand, if the underlying volume groups do not have enough free space, the logical volume can be extended by adding another physical volume to extend the underlying volume group first. In one exemplary implementation, bonus space is used to create the additional physical volume.

Generally, there are two approaches to creating the additional physical volume. One approach is to create a new virtual disk device to add to the volume group. The other approach is to extend the existing virtual disk device, create a new partition, and add the new partition to the volume group. Since the second option may need to reboot the system, creating a new virtual disk device is typically more convenient. After the volume group is extended the corresponding logical volume is ready to be extended. After this, the file system can be resized to perform the online extension with extra space.

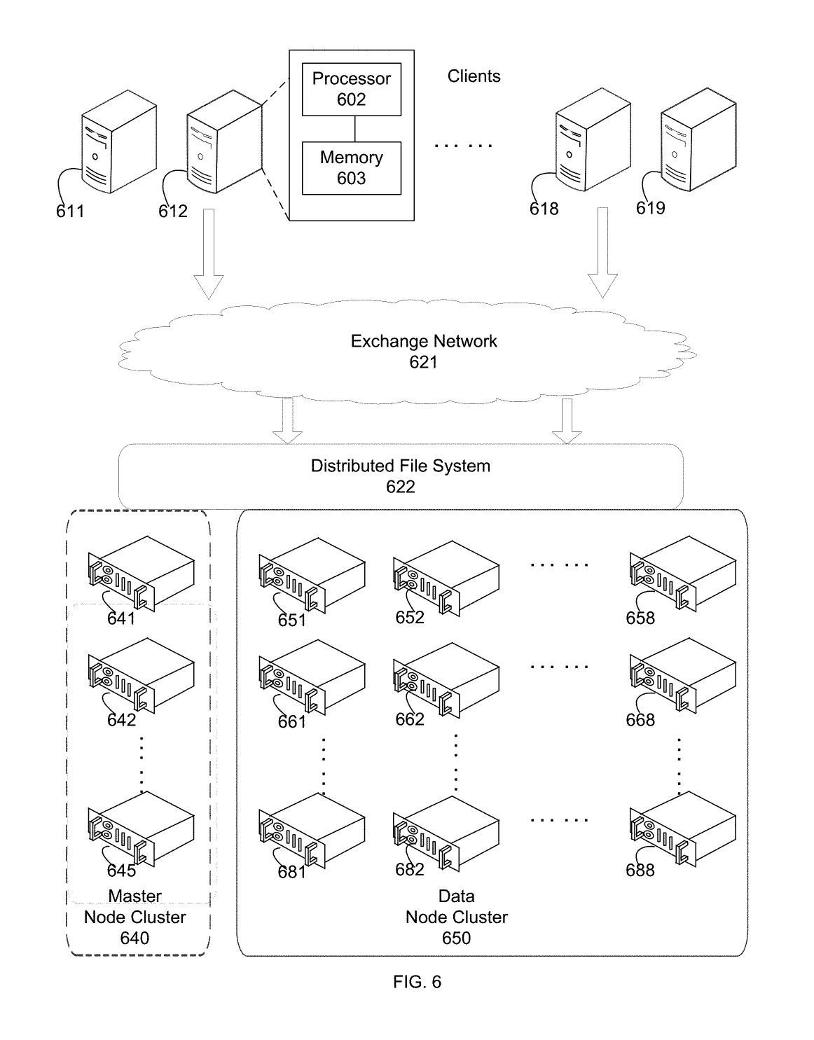

FIG. 6 is a block diagram of an exemplary distributed system simultaneously running multiple services on clusters in accordance with one embodiment. The illustration presents the top-level architecture of a distributed system. The front-end clients 611, 612, 618, and 619 collect users' real-time requests and forward their requests through the exchange network 621 to the distributed file system 622. Data storage is based on meta data stored in master node cluster 640, which includes master nodes 641, 642 and 645. User data is distributed and stored in the data node cluster 650. Data node cluster 650 includes data nodes 651, 652, 658, 661, 662, 668, 681, 682, and 688. To improve the efficiency and utilization of the infrastructure, multiple services can run simultaneously on the clusters. Some of the services request relatively higher storage capacity, and others request relatively greater computation resources.

From a storage point of view, this can mean the content of data being stored is diversified. Since the mixed workload can form a global balance on contents, this makes the data condensing scheme valuable with a reasonable data condensing rate. In one embodiment, data condensing includes efforts to remove redundancy in the original user data and also mitigates the potential suboptimal processing in the OS stack.

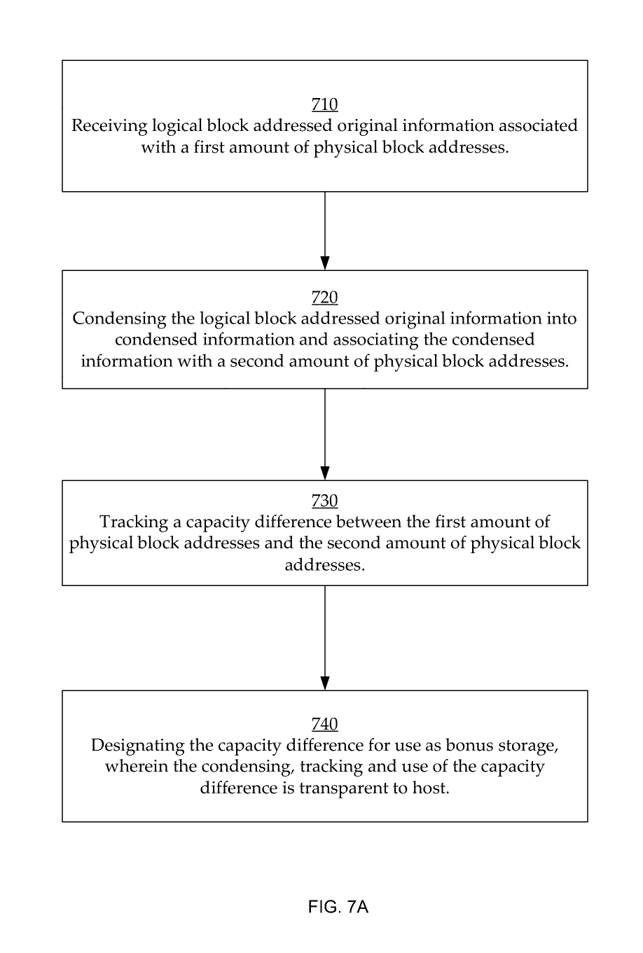

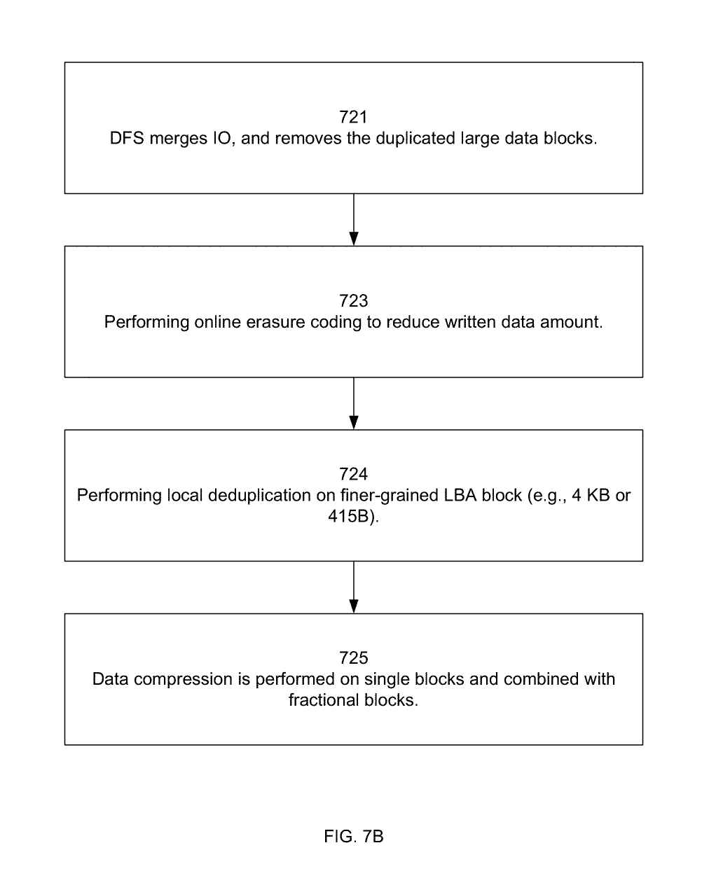

FIG. 7A is a block diagram of a bonus storage method in accordance with one embodiment.

In block 710, logical block addressed original information is received. The logical block addresses original information is associated with a first amount of physical block addresses.

In block 720, the logical block addressed original information is condensed. The condensed information is associated with a second amount of physical block addresses. In one embodiment, there are fewer physical blocks in the second amount of physical block addresses than there are physical blocks in the first amount of physical block addresses. There can also be fewer physical blocks in the second amount of physical block addresses than there are logical blocks in the logical block addressed original information. The second amount of physical block addresses can be a sub set of the first amount of physical block addresses.

In block 730, a capacity difference between the first amount of physical block addresses and the second amount of physical block addresses is tracked.

In block 740, the capacity difference is designated for use as bonus storage. The condensing, tracking and use of the capacity difference is transparent to a host. The bonus storage can be used to create a bonus drive. In one embodiment, the bonus storage can be used to create a bonus drive after a logical block address count of an original drive is used up. In one exemplary implementation, the capacity of the bonus drive is updated after a group of write operations. A logical block count of the bonus dive can vary.

In one embodiment, the tracking in block 730 and the designating capacity difference in block 740 is performed in a middle translation layer between a logical block address layer and a flash translation layer. The middle translation layer ensures compatibility with a host. The middle translation layer can handle updates to form a bonus drive based upon the capacity difference. In one exemplary implementation, a middle block address count and a physical block address count are the same and constant during usage. The middle translation layer operations can create self-defined unique interfaces between the host and flash translation layer to realize creation of bonus drives.

FIG. 7B is a block diagram of an exemplary data condensing method in accordance with one embodiment. The method comprises processing stages and work flow included in a data condensing scheme.

In block 721, the distributed file system (DFS) merges inputs/outputs (IOs) from different clients and divides the data into large data blocks (e.g., a few megabytes in size). The large data blocks are respectively tagged with the unique hash values and tracked in a library. If a large block has a hash value that is already in the library, the large data block is not passed to the next step for storage, but the system simply updates the meta data to point to the unique large data block correspondingly.

In block 723, online erasure coding is performed to reduce the amount of data actually written in the physical storage.

In block 724, local deduplication on a finer-grained LBA block basis (e.g., 4 KB, 415B, etc.) is performed.

In block 725, data compression is performed on single blocks and combined with fractional blocks.

In one embodiment, instead of keeping 3 copies of the large blocks, the online erasure coding is applied with a rate in the range of 1-1.5, which reduces at least 50% of the data to be moved to the next level. To realize this goal, the erasure coding computation can be accomplished through co-processors (which are more feasible and efficient) rather than the CPUs. After being spread through the storage fabric, local deduplication further cuts the large data block into finer-grained small data blocks of similar granularity. Hashes of the small data blocks are obtained and checked to further remove the repeated small blocks (similar to the hash checking of the large data blocks). The small data blocks sent to drives where the compression engines work on each block. After the 3 main steps described above, the data is condensed considerably. The data condensing rate is the ratio of the written data versus the original data, which is expressed in the formula below.

$$condense rate = \frac{condensed data block amount}{original user data block amound} \times 100 \%$$

The data condensing scheme is transparent to a user and the file system, and is different from traditional compression which updates the file system as well. In one embodiment, the bonus storage scheme makes a user feel more original information LBAs can be stored on the fly than actual PBAs used, so the file system does not need to make changes to be compatible. The condensed data is in the format written in the physical media together with its related meta data. Since the condensed data is less than the original user data in general, the count of PBAs used to store data is less than the count of LBAs passed from the file system. Therefore, after the condensing flow in FIG. 7, drive capacity is equivalently enlarged.

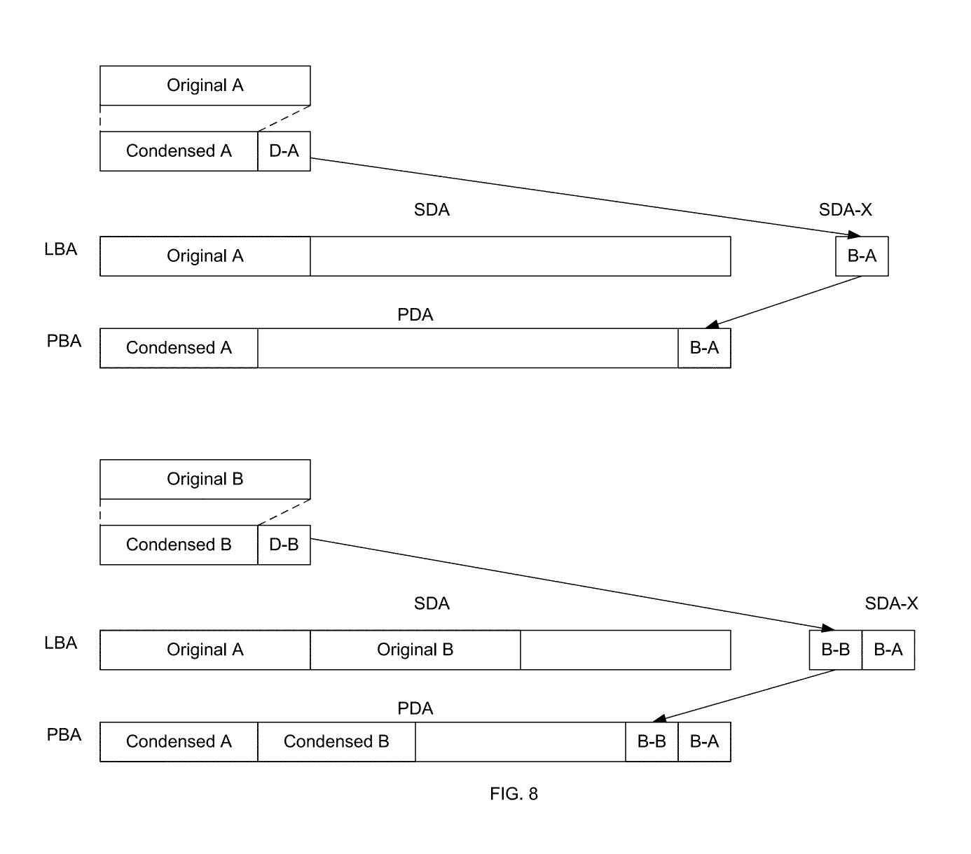

FIG. 8 is a block diagram of a bonus drive generation mechanism in accordance with one embodiment. At a first time, original data A is received in response to a user initiated write. After condensing the data, original data A is converted into condensed data A, with the capacity saving being the difference D-A between the size of original data A and condensed data A. The capacity saving is tracked as bonus storage space B-A. At a second time, original data B is received and condensed to generate condensed data B, with the capacity saving being the difference D-B between the size of original data B and condensed data B. The capacity savings is tracked as bonus storage space B-B.

In one embodiment, a bonus drive is virtually created and named SDA_x. This bonus drive can be presented to users as another drive to store further contents without practically mounting a new drive. The actual count of PBAs on the SSD drive does not change, but the storage capacity made available through data condensing (e.g., B-A and B-B) can be used for storing additional information. During the usage of the drive, capacity of SDA_x can be updated after each bunch of write operations. In one embodiment, the bonus drive SDA_x will not be used either for read or for write until other portions of the drive is full. In one exemplary implementation, only after the drive's original LBA count is used up is the bonus drive applied.

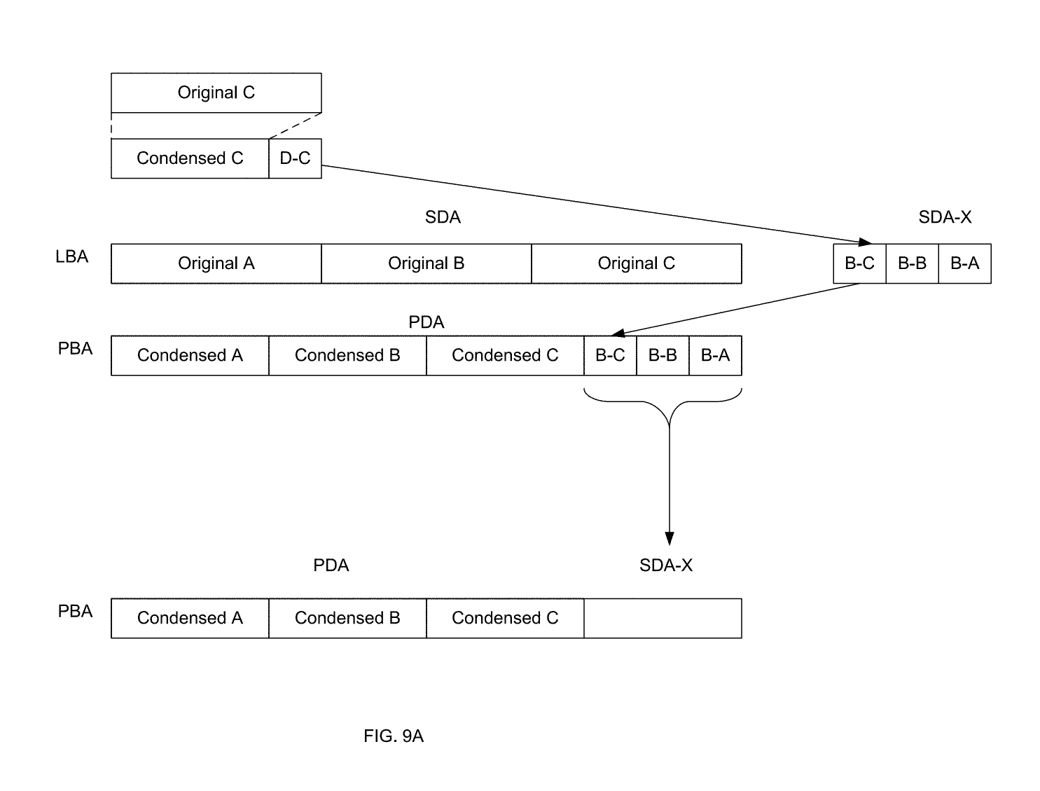

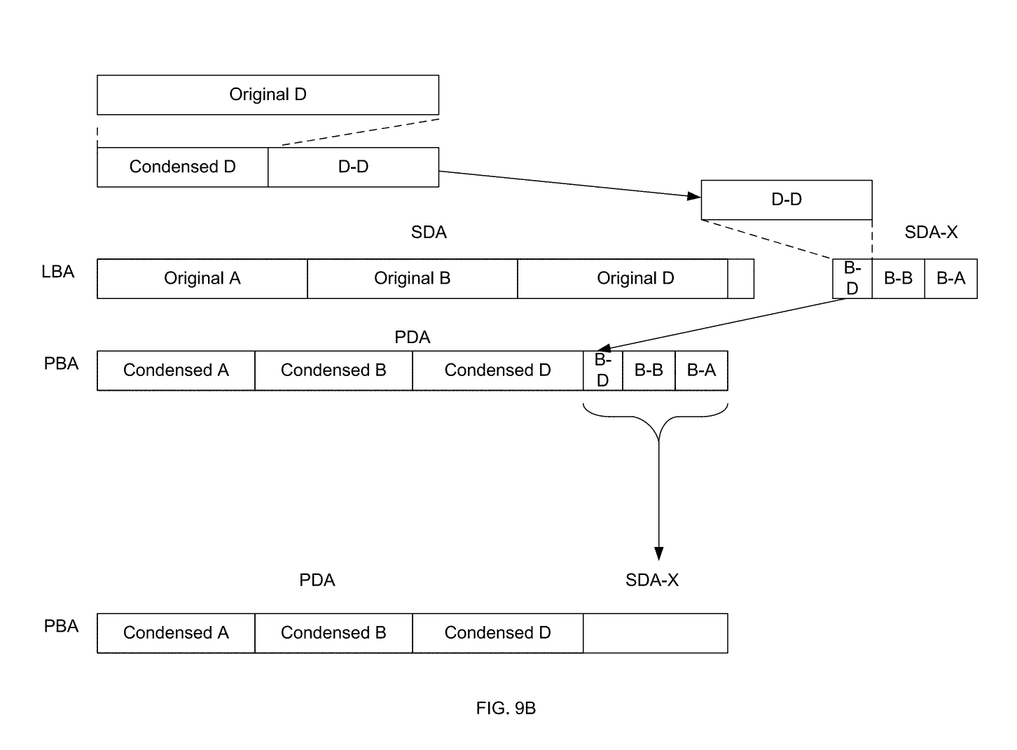

FIG. 9A is a block diagram of an exemplary application of a bonus drive in accordance with one embodiment. Continuing with information storage from FIG. 8, at a third time, original data C is received and condensed to generate condensed data C, with the capacity saving being the difference D-C between the size of original data C and condensed data C. The capacity savings are tracked as bonus storage space B-C. In one embodiment, since the drive's original LBA count is used up by the original data A, B and C and just the bonus storage space B-A, B-B, and B-C is available, the new drive SDA-X is applied and made available for use.

In one exemplary implementation, the procedure can be relatively straightforward. Before the nominal capacity of one drive is fully occupied, only certain information needs to be passed to an upper level. Nothing needs to be done on the physical drive at this stage. At a later stage, the SDA_x mapping relation between additional LBAs and the bonus capacity PBAs is built online during the usage of SDA_x. To realize the interpretation and representation of the additional LBAs and the bonus capacity PBAs, a middle translation layer (MTL) is used between the host file system and flash translation layer (FTL). The MTL handles the information accumulation and updates of PBA assignments to the original drive and the bonus drive.

It is appreciated the original data for each write does not have to be the same size. FIG. 9B is another block diagram of an exemplary application of a bonus drive in accordance with one embodiment. Continuing with information storage from FIG. 8, at a third time, original data D is received and condensed to generate condensed data D, with the capacity saving being the difference D-D between the size of original data D and condensed data D. Even though all the capacity savings D-D can not be used, the portion of capacity savings D-D that can be used is tracked as bonus storage space B-D. Since the original drive's LBA count is used up by the condensed data A, B and C and the bonus storage space B-A, B-B, and B-C, the new drive SDA-X is applied.

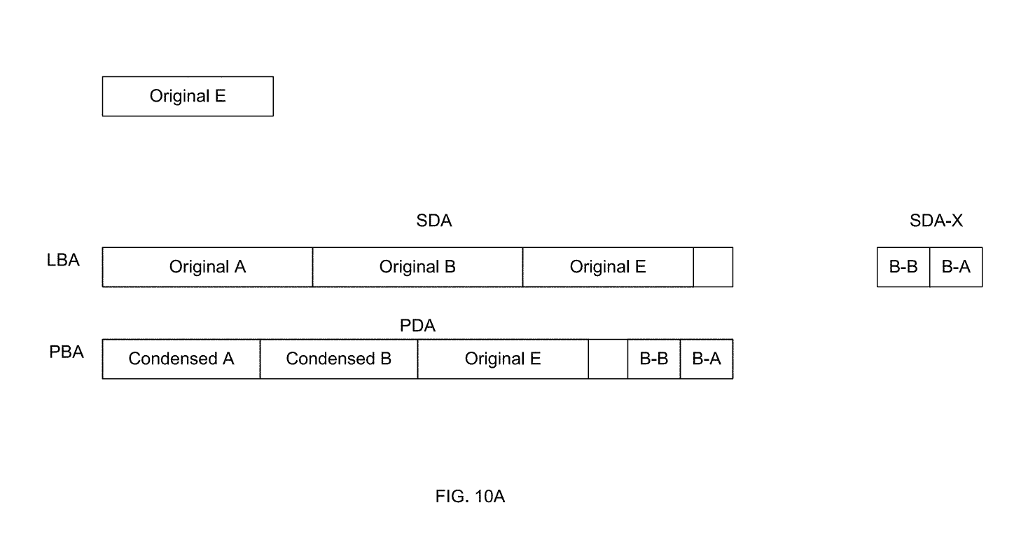

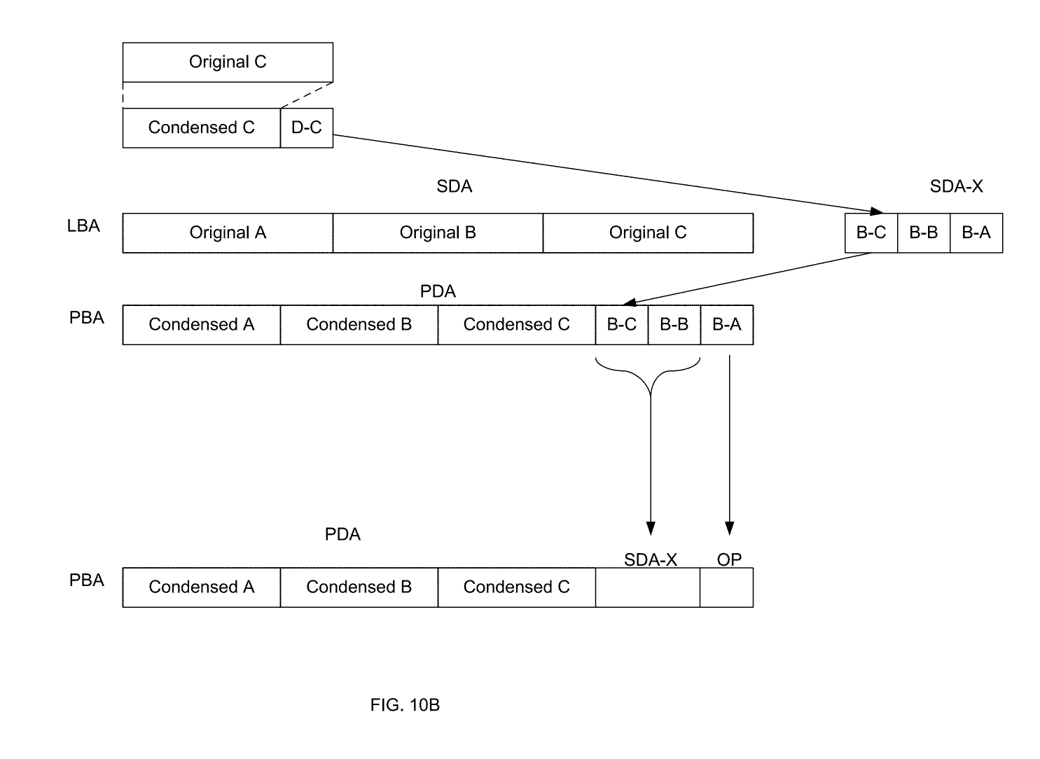

FIG. 10A is a block diagram of a bonus drive generation mechanism in accordance with one embodiment where some original data is not condensed. In one embodiment, it is not efficient to attempt to condense some of the original data. Continuing with information storage from FIG. 8, at a third time, original data E is received but not condensed. The original data E is stored in the PDA. Even though there are no capacity savings associated with original data E, the bonus storage space B-A, and B-B are still tracked and available for use.

FIG. 10B is a block diagram of an exemplary application of utilizing bonus capacity in accordance with one embodiment. The status of the information updates are similar to those in FIG. 9A. Again, the capacity savings are tracked as bonus storage space B-A, B-B, and B-C. In one embodiment, since the drive's original LBA count is used up by the original data A, B and C and just the bonus storage space B-A, B-B, and B-C is available, a decision can be made on how to use the bonus storage space B-A, B-B, and B-C. It is appreciated that the bonus storage spaces B-A, B-B, and B-C can be used in a variety of configurations. At least a portion of bonus storage space (e.g., B-B, and B-C, etc.) are applied to the configuration of new drive SDA-X, which is made available for use. Another portion of bonus storage space (e.g., B-A, etc.) can be made available for over-provisioning (OP) use.

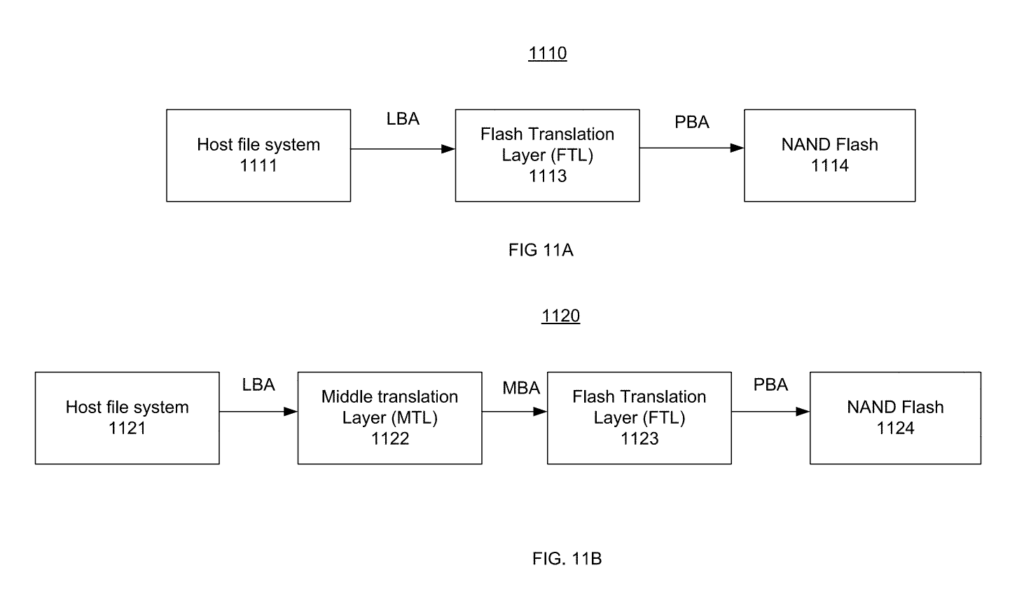

FIG. 11A is a block diagram of a traditional approach 1110 without a middle translation layer (MTL). Traditional approach 1110 includes host file system 1111, flash translation layer (FTL) 1113 and NAND flash 1114. FIG. 11B is a block diagram of an exemplary middle translation layer (MTL) approach 1120 in accordance with one embodiment. Middle translation layer (MTL) approach 1120 includes host file system 1121, middle translation layer 1122, flash translation layer (FTL) 1123 and NAND flash 1124. In one exemplary implementation, storage space that is exposed to a host for use with original LBAs is gradually extracted for use as bonus storage space. A middle block address (MBA) can be used for this purpose. With the insertion of an MTL, two main functions are implemented. One main function is to dynamically update the capacity of the bonus drive to the host. However, in situations where the bonus drive will not be accessed until the other space in the original drive is fully occupied, this update will not actually lead to the immediate occupation of bonus drive after each update. This means there can be updates whose primary purpose is to synchronize for informative purposes. The other main function of the MTL is to ensure the compatibility with the host, so that the file system and applications do not need to change or even be aware of the changes in the PBA use. The host can simply take advantage of the “additional capacity” of the bonus drive. The capacity of physical media can be exploited to service both the original LBAs and new bonus LBAs during usage by implementation of the middle translation layer.

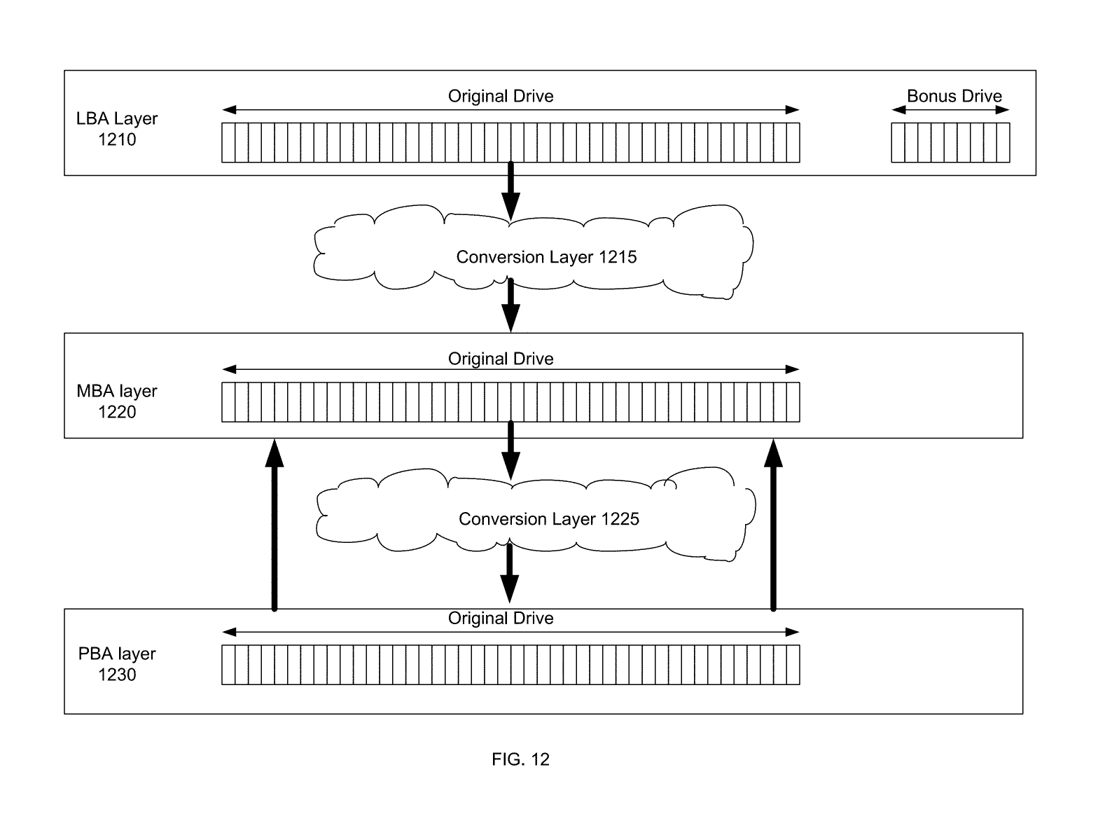

In one embodiment, the MBA count and the PBA count is directly decided by the physical capacity and the block size, which remain constant during usage. The LBA count of the original drive part is also constant and the same as the MBA count. However, based on different data content the LBA count of the bonus drive may vary. The conversion layer uses the results of global deduplication and local deduplication previously described, and keeps the global deduplication's meta data at master nodes, while keeping the local deduplication's meta data at the local node. These convert into the format in FIG. 12.

FIG. 12 is a block diagram of an exemplary format conversion hierarchy in accordance with one embodiment. The format conversion hierarchy includes LBA layer 1210, conversion layer 1215, MBA layer 1220, conversion layer 1225, and PBA layer 1230. The conversion is from LBA to PBA through MBA enabling the bonus capacity exploit in accordance with one embodiment. The small data block (e.g., MBA) is passed into the NAND flash controller and compressed further, resulting in a more condensed format. The corresponding meta-data for compression is fed back to the MTL, and the condense meta-data is reformed by combining the compression with local deduplication information. This is shown in FIG. 12 as the two arrows from PBA layer to MBA layer. In one embodiment, the condense processing chain includes global deduplication, local deduplication and compression ends, and the condense metadata in MTL is stored in the PBA together with the header and data itself. In one exemplary implementation, the MTL is the place to buffer the intermediate outcomes and further process them into the condensed format.

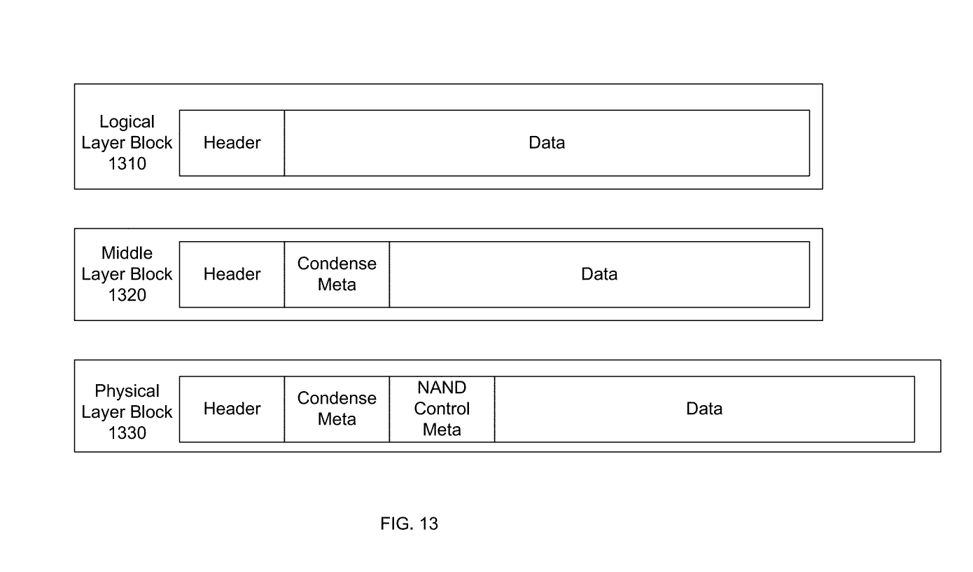

FIG. 13 is a block diagram of the storage block formats at different layers in accordance with one embodiment. The storage block formats include logical layer block format 1310, middle translation layer block format 1320, and physical layer block format 1330. The local deduplication's meta data is inserted between the user data's header and the data portion as shown in physical layer block format 1330 of FIG. 13 (denoted as condensed meta-data).

With reference back to FIG. 4, after compression related control information is generated. The generated control information is named NAND control meta in physical layer block format 1330 in FIG. 13. For example, the private keys for encryption, the configuration of ECC, the raid information, etc. are often stored as NAND control meta data. FIG. 13 is presented for illustration purpose, however, the data portion itself does not need to be same-length or size.

In one embodiment, the efficiency of data condensing can also be managed globally to exploit the potential of the overall storage system configuration. The real-time data condensing ratio is monitored from time to time, and analyzed to figure out a way to mix data contents from multiple services, to switch on data condensing per load burden, and to expose the bonus drive capacity. If the statistics prove that the compression may hardly be able to reduce the data amount, one flag is issued to bypass the compression from the control and analysis panel.

Condensing in the bonus storage capacity approaches can also facilitate write amplification reduction. A condensed chunk of data is on average shorter than the original data chunk and less space is used to effectively store the host original data. Therefore, less information is written in the actual physical storage. The compression's advantage of writing less data can help with mitigation of write amplification in an SSD. Write amplification arises because flash memory is erased before it is rewritten and the amount of storage space involved in erase operations and write operations are typically different. The difference between storage space involved in erase operations versus write operations can result in much larger portions of flash being erased and rewritten than are actually required to accommodate the amount of new or updated data. Thus, if less data is written there is likely less portions needing to be erased and less opportunity for write amplification to occur. Thus condensing in the bonus storage capacity approaches also helps mitigate write amplification.

However, while condensing can help with write amplification and fewer bits are written in fact, the total amount of host data that can be written into a conventional SSD does not increase. In a conventional approach the total number of LBAs that one SSD displays to the host is directly bonded with the nominal capacity of the SSD. This situation can reduce the benefit of a compression function in SSD with regards to storage capacity. The bonus storage approaches enable a system to remain compatible with the conventional storage approaches so that it is compatible with legacy systems, while providing additional bonus storage that conventional systems can not typically provide.

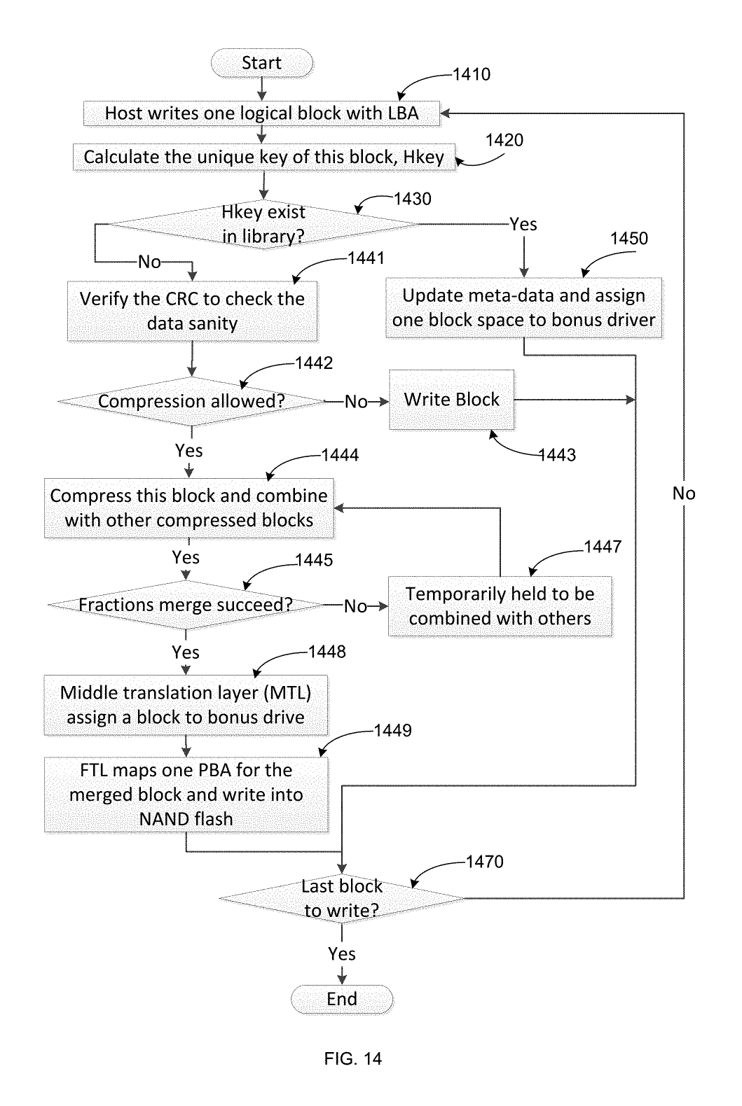

FIG. 14 is the flow chart of an exemplary data scheme condensing method in accordance with one embodiment.

In step 1410, the host writes one logical block with a LBA.

In step 1420, the unique key for the block in step 1410 is calculated.

In step 1430, a determination is made if the unique key exists in a library. If the unique key exists the process proceeds to step 1450. If the unique key does not exist the process proceeds to step 1441.

In step 1441, the CRC is verified. This can provide an indication of the correctness or “sanity” of the data.

In step 1442, a determination is made if compression is allowed. If compression is allowed the process proceeds to step 1444. If compression is not allowed the process proceeds to step 1443.

In step 1443, the data is written and the process proceeds to step 1470.

In step 1444, the block is compressed and combined with other compressed blocks.

In block 1445, a determination is made if the fraction merging is successful. If the fraction merging is successful the process proceeds to block 1448. If the fraction merging is not successful the process proceeds to block 1447.

In block 1447, the process temporarily holds the data to be combined with others and returns to step 1445.

In block 1448, the middle translation layer assigns a block to the bonus drive.

In block 1449, the FTL maps one PDA for the merged block and writes into NAND flash.

In block 1470, a determination is made if the current block is the last block to write. If the current block is not the last block to write the process returns to step 1410. If the current block is the last block to write the process proceeds to step 1470.

In one embodiment, systems and methods can expose incremental storage capacity to users on the fly. The additional capacity can be presented as the bonus drive enabling storage space to be used with improved efficiency. In one exemplary implementation, a system and method includes the integration of multiple layers through user space applications, a distributed file system, a conventional file system, block layer, a NAND storage driver (which can include both software and firmware) and hardware configuration of a compression engine control scheme. In one exemplary embodiment, a middle translation layer component (e.g., middle translation layer component 483, etc.) implements a bonus capacity storage method (e.g., similar to the method illustrated in FIG. 1, FIG. 7A, etc.) in a controller (e.g., embedded processor, application specific integrated circuit (ASIC), field programmable gate array (FPGA), etc.) of an SSD.

The systems and methods can include intelligent monitoring, analysis and decision making to bypass compression and data content mixture for global optimization of data condensing efficiency. For certain scenarios with less margin of data condensing, the compression portion is bypassed. Meanwhile, with respect to distribution of data content among clusters, the 10 merging and chunk cutting from a distributed file system can facilitate storage space optimization more globally. As a result, the system can efficiently expose extra bonus drives which can be used without physically mounting new drives.

A middle translation layer (MTL) can bridge a file system and a flash translation layer of NAND flash storage. The MTL can make the file system and user space program be naturally compatible with layers underneath. The MTL can function as a bridge to buffer then further process the information. The MTL can also combine meta-data into the bonus capacity flow and bonus capacity format. This can be implemented through the self-developed driver running in the kernel space. In one embodiment, self-defined unique interfaces and communication protocols are created to realize the information exchange. A bonus drive can work with logical volume management and minor differences in the capacity of bonus drives are efficiently handled. The multiple-layer translation can facilitate modular tasks operations. The multiple-layer translation can make assignments along with informative notification and recursive feedback. The bonus drive capacity is incrementally adjusted per the actual in-situ data condensing.

Thus, the presented data compressing storage systems and methods facilitate efficient processing and storage. The systems and methods can gradually expose additional capacity to a file system without physically mounting additional drives. The incremental capacity can be configured in the format of a bonus drive in a logical volume. The bonus drive can be created for additional writes after the original drive is full. The system can perform in-situ data condensing rate analysis, then accordingly adjust the data content mixture in the recursive manner. The newly introduced middle translation layer accomplishes the information synchronization and meta-data buffering, updating and reforming. The data condensing that integrates the global deduplication, local deduplication and need-based compression is manipulated through the self-developed MTL to exploit the space saving potential, where the resulting saving is used for the bonus drive. The bonus drive can be used as a normal logical volume without a need to change the file system or user space applications.

Some portions of the detailed descriptions are presented in terms of procedures, logic blocks, processing, and other symbolic representations of operations on data bits within a computer memory. These descriptions and representations are the means generally used by those skilled in data processing arts to effectively convey the substance of their work to others skilled in the art. A procedure, logic block, process, etc., is here, and generally, conceived to be a self-consistent sequence of steps or instructions leading to a desired result. The steps include physical manipulations of physical quantities. Usually, though not necessarily, these quantities take the form of electrical, magnetic, optical, or quantum signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that of these and similar terms are associated with the appropriate physical quantities and are merely convenient labels applied to these quantities. Unless specifically stated otherwise as apparent from the following discussions, it is appreciated that throughout the present application, discussions utilizing terms such as “processing”, “computing”, “calculating”, “determining”, “displaying” or the like, refer to the action and processes of a computer system, or similar processing device (e.g., an electrical, optical, or quantum, computing device), that manipulates and transforms data represented as physical (e.g., electronic) quantities. The terms refer to actions and processes of the processing devices that manipulate or transform physical quantities within a computer system's component (e.g., registers, memories, other such information storage, transmission or display devices, etc.) into other data similarly represented as physical quantities within other components.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents. The listing of steps within method claims do not imply any particular order to performing the steps, unless explicitly stated in the claim.

What is claimed is:

1. A method comprising:
receiving a first amount of original information associated with a first set of logical storage address blocks;
condensing the first amount of original information into a first amount of condensed information wherein a size of the first amount of condensed information is smaller than the first amount of original information and the difference is a first capacity saving;
storing the first amount of condensed information in a first set of physical storage address blocks;
tracking the first capacity saving; and
using at least a portion of the first capacity saving for storage activities other than a direct bonding address coordination space for the first amount of original information.

2. The method of claim 1, further comprising:
receiving a second amount of original information associated with a second set of logical storage address blocks;
condensing the second amount of original information into a second amount of condensed information, wherein the size of the second amount of condensed information is smaller than the second amount of original information and the difference is a second capacity savings;
storing the second amount of condensed information in a first set of logical storage address blocks;
tracking the second capacity savings; and
using at least a portion of the second capacity saving for storage activities other than a direct bonding address coordination space for the second amount of original information.

3. The method of claim 1, wherein the storage activities other than the direct bonding address coordination space include converting the first capacity saving into a new bonus drive.

4. The method of claim 1, wherein the tracking of the first capacity saving and the using of at least a portion of the first capacity saving is transparent to a host, and the host continues to consider the physical block addresses assigned to the original data.

5. The method of claim 1, wherein a bonus mapping relation is performed in a middle translation layer between a logical block address layer and a flash translation layer.

6. The method of claim 1, wherein adjustments to the first capacity saving are performed during actual in-situ data condensing.

7. The method of claim 1, wherein the storage activities other than a direct bonding address coordination space includes over-provisioning.

8. A storage system comprising:
a host interface configured to receive information from a host and send information to a host, wherein the information includes original information configured in accordance with logical block addresses;
a condensing component configured to condense the original information into condensed information;
a middle translation layer component configured to arrange the condensed information in accordance with middle translation layer block addresses and track capacity savings due to a difference in the original information and the condensed information; and
a NAND flash storage component that stores the condensed information in accordance with physical block addresses and provides feedback to the middle translation layer component.

9. The system of claim 8, wherein the middle translation layer component initiates creation of a new drive based upon the capacity savings.

10. The system of claim 8, wherein the middle translation layer component performs operations on a modular level enabling recursive feedback from the physical layer.

11. The method of claim 8, wherein use of the first capacity saving for storage activities other than a direct bonding address coordination space for the first amount of original information are transparent to the host.

12. A method comprising:
receiving logical block addressed original information associated with a first amount of physical block addresses;
condensing the logical block addressed original information into condensed information and associating the condensed information with a second amount of physical block addresses;
tracking a capacity difference between the first amount of physical block addresses and the second amount of physical block addresses; and
designating the capacity difference for use as bonus storage, wherein the condensing, tracking and use of the capacity difference is transparent to a host.

13. The method of claim 12, wherein the bonus storage is used to create a bonus drive after a logical block address count of an original drive is used up.

14. The method of claim 13, wherein capacity of the bonus drive is updated after a group of write operations.

15. The method of claim 13, wherein a logical block count of the bonus dive varies.

16. The method of claim 12, wherein the tracking and the designating the capacity difference is performed in a middle translation layer between a logical block address layer and a flash translation layer.

17. The method of claim 16, wherein the middle translation layer ensures compatibility with a host.

18. The method of claim 16, wherein the middle translation layer handles updates to form a bonus drive based upon the capacity difference.

19. The method of claim 16, wherein a middle translation layer block address count and a physical block address count are the same and constant during usage.

20. The method of claim 16, wherein the middle translation layer operations create self-defined unique interfaces between the host and flash translation layer to realize creation of bonus drives.
